(19) United States
(12) Patent Application Publication
(10) Pub. No.: US 2017/0163025 A1
(43) Pub. Date: Jun. 8, 2017

(54) METHOD FOR OPERATING AN AT LEAST GENERATOR-OPERABLE ELECTRIC MOTOR AND MEANS FOR THE IMPLEMENTATION THEREOF

(71) Applicant: Robert Bosch GmbH, Stuttgart (DE)

(72) Inventor: Matthias Schmidt, Stuttgart (DE)

(21) Appl. No.: 15/325,792

(22) PCT Filed: Jul. 14, 2015
(86) PCT No.: PCT/EP2015/066022

§ 371 Date: Jan. 12, 2017

(30) Foreign Application Priority Data
Jul. 25, 2014 (DE) 10 2014 214 639.9

(51) Int. Cl. H02H 7/06; H02P 9/10; H02P 9/00

(52) U.S. Cl. CPC H02H 7/067; H02P 9/006; H02P 9/107; H02P 9/102

(57) ABSTRACT

A method for controlling a multi-phase electric machine, whose phase terminals in an active bridge rectifier are respectively connected, via controllable first current valves, to a first DC voltage terminal and via second current valves to a second DC voltage terminal. The method includes switching on the first current valves when an output voltage between the first DC voltage terminal and the second DC voltage terminal has exceeded an upper threshold value at an exceedance point in time, and shutting off the first current valves again only once the output voltage has subsequently fallen below a lower threshold value at a shortfall point in time. The first current valves are shut off again after the shortfall point in time individually, and each only when a respective indication value, which characterizes a current flow in the phase terminal associated with the respective current valve, exhibits a predetermined property.

### FIELD

The present invention relates to a method for operating an electric machine, operable at least in generator mode and having an active bridge rectifier, and to an implementation thereof.

### BACKGROUND INFORMATION

Generators of the claw pole type, having passive bridge rectifiers, are conventionally utilized in passenger cars. The output of such generators is adjusted via the excitation field, and that in turn via the excitation current. The output voltage of the generator can be held constant, regardless of network load, rotation speed, and temperature, by regulating the excitation field.

When what is discussed hereinafter is simply a “generator,” this can refer to an electric machine operable in both generator mode and motor mode, for example a so-called “starter generator.” The present invention is suitable not only for claw pole-type generators but instead for all electric machines operable at least in generator mode. In passenger cars, bridge rectifiers in a six-, eight-, or ten-pulse configuration, corresponding to the three-, four-, or five-phase generators that are usually installed, are usually used. The present invention is also suitable, however, for bridge rectifiers having different numbers of phases.

A load discontinuity in the connected network, for example due to connection or disconnection of a load, results in a load discontinuity at the generator. But because the power delivery of the generator cannot be modified arbitrarily quickly due to the inductance of the excitation field, the generator current initially remains approximately constant, which in the context of a load dump can result in an appreciable increase in the output voltage. Dissipation of the excitation field can take several hundred milliseconds.

As long as a battery is present in the vehicle electrical system, that battery generally can absorb the excess generator output and thus prevent an excessive voltage rise. If a battery is not present, however, the output voltage then rises very quickly and is capable of damaging electrical system components and/or the generator.

In generators having passive bridge rectifiers, this is prevented by using Zener diodes as rectifier diodes. The Zener diodes clamp the output voltage above their breakdown voltage, and are therefore capable of absorbing excess current and converting it into heat. Reliable operation of the generator is thereby always ensured.

Controllable current valves capable of being switched on and shut off, in particular MOSFETs, can also be used instead of the rectifier diodes in bridge rectifiers. An advantage is their lower power loss in the switched-on state, and thus better efficiency for the generator overall, especially at part load. The current valves can be controlled in centralized or decentralized fashion. A “centralized” control system is understood to mean that one common control device monitors all the alternating current phases and controls all the current valves, and optionally also the excitation field of the generator. A “decentralized” control system is understood to mean that one control unit respectively controls one generator phase, and controls, as a function of the phase voltage, only the current valves associated with the respective phase, i.e., only the current valves of a respective half-bridge. A decentralized control system can be implemented with or without communication between the individual decentralized control devices.

In the context of active bridge rectifiers, one possibility for preventing voltage spikes in the vehicle electrical system in the event of a load dump is to switch on the respective current valves of the upper or the lower rectifier branch in all the half-bridges. The result is that the electric machine is internally short-circuited but not the connected network.

The measures just explained are also referred to hereinafter as a “phase short circuit.” According to the terminology used here, a phase short circuit is therefore initiated by switching on (making conductive) all the current valves (“low-side” current valves) that switch to ground or to a negative DC voltage terminal (see also DC voltage terminal B− in accordance with FIG. 1 explained below), or alternatively all the current valves (“high-side” current valves) that switch to a positive DC voltage terminal (see also DC voltage terminal B+ in FIG. 1) of the rectifier, and correspondingly discontinued by shutting off those current valves. If field effect transistors are used, for example, as current valves, those current valves are then switched on in this context by furnishing a corresponding control voltage to their gate terminal (addressing), with the result that the drain-source section of the current valves becomes conductive or low-impedance. The current valves are correspondingly shut off by terminating the provision of control voltage, and the drain-source section becomes non-conductive or high-impedance. In the absence of a phase short circuit, ordinary rectifier operation prevails.

A phase short circuit can be initiated, for example, when the voltage between the DC voltage terminals of the bridge rectifier (usually referred to as B+ and B−), or between the voltage-carrying DC voltage terminal and ground, exceeds an upper threshold value. The phase short circuit can be discontinued again when that voltage then falls below a lower threshold value.

During the phase short circuit, an additional positive or negative DC component occurs respectively in the phase currents of the AC phases due to initiation of the short circuit. The phase currents become more or less asymmetrical as a result, i.e., no longer oscillate around a common average value or zero. The sum of the DC components is equal to zero.

If the phase short circuit is canceled in the context of a shortfall below the aforementioned lower threshold value, then in the phases having an instantaneously positive current, the latter commutates into the current valve of the upper rectifier branch, i.e., the one connected to the positive DC voltage terminal, as long as the phase voltage exceeds the voltage in the connected network. Because of the asymmetry just explained, in some circumstances high currents must be switched; this causes corresponding stress on the participating current valves. This can result in damage to those current valves.

It is therefore desirable to eliminate or at least reduce the stress on corresponding current valves upon discontinuation of a phase short circuit.

### SUMMARY

An example method for operating an electric machine, operable at least in generator mode and having an active bridge rectifier, and an implementation thereof are provided. Embodiments are described herein.

In order to avoid the need for the current valves involved in a phase short circuit to switch excessively large currents upon discontinuation of a corresponding phase short circuit, provision can be made to shut off such current valves again only when the corresponding phase current is as low as possible, in particular at the zero crossing of the phase current. But because the respective lowest current values or zero crossings of the individual phase currents of course occur at different points in time (corresponding to the electrical angle of the stator windings with respect to one another), in such cases the shutoff of the corresponding current valves necessarily also does not occur simultaneously.

The shutoff of the current valves of a phase can, however, bring about an additional asymmetry in the phases that still have switched-on current valves, due once again to a higher, non-decaying DC component. The result is therefore that there can still be phases in which a zero crossing no longer occurs, or in which the phase currents no longer become low enough to fall below a predefined fixed comparison value. The current valves would therefore remain continuously activated in those phases. A corresponding result can also be caused, however, simply by the DC components impressed upon initiation of the phase short circuit.

The present invention provides an example method for controlling a multi-phase electric machine, operable at least in generator mode, whose phase terminals in an active bridge rectifier are respectively connected, via controllable first current valves capable of being switched on and shut off, to a first DC voltage terminal and via second current valves to a second DC voltage terminal, the method includes: in a generator mode of the electric machine, switching on the first current valves when an output voltage between the first DC voltage terminal and the second DC voltage terminal has exceeded an upper threshold value at an exceedance point in time, and shutting off the first current valves again only once the output voltage has subsequently fallen below a lower threshold value at a shortfall point in time. Provision is made according to the present invention that the first current valves are shut off again after the shortfall point in time individually, and each only when a respective indication value, which characterizes a current flow in the phase terminal associated with the respective current valve, exhibits a predetermined property.

In the context of the present invention as described herein, a “controllable current valve capable of being switched on and shut off” is understood as a semiconductor switch that furnishes a low-impedance or conductive connection as long as an addressing voltage is applied to a terminal provided therefor. Such controllable first current valves capable of being switched on and shut off are, in particular, MOSFETs and/or IGBTs, which can be addressed via their gate terminal and can furnish the low-impedance or conductive connection via the drain-source section. Controllable current valves capable only of being switched on, which are not a subject of the present invention, are e.g. thyristors. Diodes are likewise current valves, but are not controllable.

As mentioned, in the method according to the present invention, the first current valves are shut off again after the shortfall point in time individually, and each only when a respective indication value, which characterizes a current flow in the phase terminal associated with the respective current valve, exhibits a predetermined property. According to a particularly preferred embodiment, such a property can encompass the fact that the indication value is below a maximum value, the maximum value being elevated during a time span that is after the shortfall point in time.

In specific cases, however, it can also be advantageous if the predetermined property encompasses the fact that the indication value exhibits a minimum determined by way of a determination specification. A determination specification can encompass, for example, a minimum determination by way of a differentiation, known per se, of a corresponding signal.

If the aforementioned embodiment of the present invention, in which the predetermined property encompasses the fact that the indication value is below a maximum value, is used; and if that maximum value, as indicated, is elevated during a time span that is after the shortfall point in time after which the phase short circuit can in principle be discontinued again, a shutoff of a current valve then occurs even when the phase current or a corresponding indication value no longer exhibits a zero crossing or is elevated because of the DC component impressed upon initiation of the phase short circuit and/or upon shutoff of other current valves.

Advantageously, the maximum value at the shortfall point in time initially corresponds to a zero value of the phase current in the phase associated with the respective current valve, or of a corresponding indication value. A corresponding zero value can correspond, for example to the zero crossing or the reversal point of a corresponding sinusoidal current, or to a magnitude of the indication value correlating therewith.

If the maximum value is initially held at that zero value, this makes it possible for the phase currents that still exhibit a corresponding zero crossing to be switched at a lowest possible current value, thereby reducing the stress on the participating current valves. The elevation of the maximum value which is proposed here becomes necessary, and is engaged, only for those phases whose phase currents no longer exhibit a corresponding zero crossing.

It is particularly advantageous in the context of the present invention to begin the elevation of the maximum value only after a waiting time during which the maximum value is initially still left at the zero value. The waiting time can be set to a fixed value or can be predefined as a function of an operating parameter of the generator, in particular the rotation speed.

If the waiting time is set as a function of rotation speed, it is possible to ensure, for example, that one entire electrical period has elapsed without the respective current valve having been shut off. This is a reliable indicator that the corresponding phase current no longer exhibits a zero crossing, or that it has been elevated in such a way that it no longer falls below the maximum value corresponding to the zero value. The elevation of the maximum value which is provided according to the present invention is therefore initiated after expiration of the waiting time, and if applicable of an additional time buffer.

In the context of the present invention, the elevation of the maximum value can occur at least intermittently linearly and with a predefined steepness, or in the form of a nonlinear function. When a suitable linear or nonlinear function is defined, and in particular when its maximum is suitably selected, this ensures that after some length of time all the phase currents or corresponding indication values fall below the maximum value, and the respective current valves are thus shut off.

After a certain duration of a corresponding rise, the indication value therefore necessarily falls below the maximum value, so that the corresponding current valve is shut off. It is switched not exactly at the minimum, but (depending on the steepness of the linear function or of a corresponding parameter of a nonlinear function) sufficiently close to the minimum of the phase current or of the indication value.

The steepness of the linear function and/or at least one parameter of the nonlinear function can likewise be set in constant or rotation speed-dependent fashion. The steepness is specified, for example, in amperes per second. A rotation speed dependence has the advantage here that only a specific maximum elevation of the maximum value for each electrical period can be permitted, e.g., 10 amperes per period. It is thereby possible to ensure that the minimum of the phase current is missed at most by that value, for example 10 amperes. The steepness is advantageously selected in such a way that at a specific rotation speed, only a minimal, or maximum permissible, rise in the indication signal occurs between two minima of the corresponding phase current. For example, at 20 amperes per millisecond and with a period length of, for example, 2.5 milliseconds (at 3000 revolutions per minute and with eight pole pairs), a shift of at most 50 amperes would occur between two minima of the switching point. The minimum in the phase current is therefore missed by a maximum of 50 amperes. The less the steepness or the flatter the slope, the more accurately the minimum is hit, but it also takes increasingly longer for the phase to transition back into rectifier mode, i.e., for the corresponding current valve to be shut off. A tuning compromise, derived in particular from the reliable operating range of a corresponding current valve, is advantageous here.

The measures explained, in particular the rotation speed dependence, permit a definite optimization in terms of the rapidity of the switching or deactivation of the phase short circuit and attainment of the respective minimum. A rotation speed dependence is significant in particular because corresponding generators can be operated in extremely wide rotation speed ranges of, for example, 1500 to 20,000 revolutions per minute, so that constant times would always need to be designed for the “worst case” rotation speed (which is the lowest rotation speed), which would result in superfluous delay times at higher rotation speeds.

The example method according to the present invention proves to be remarkably robust in use, since drift both in the signal measurement and in the indication signal merely causes a shift in the time of the switching points, but switching close to the minimum can still always be ensured. This low accuracy requirement makes possible simple and inexpensive implementation (industrialization). In addition to the rotation speed, application-specific factors or additions (supplementary values) for the steepness or the starting time of a corresponding function can also be used.

All in all, stress on the current valves can be considerably reduced by way of the method according to the present invention. The example method according to the present invention furthermore can be integrated very easily, for example in an application-specific integrated circuit, and is robust with respect to tolerances in the measured signal and interference therein. A distinct advantage exists in particular as compared with differentiation of the signal. Switching only at the zero crossing, which can be error-prone, is improved.

A computation unit according to the present invention, e.g. a control device of a motor vehicle, is configured, in particular in terms of programmed execution, to carry out a method according to the present invention. An entirely analog implementation is also possible, however, for example in a suitable application-specific integrated circuit (ASIC).

Implementation of the method in the form of software is also advantageous because this results in particularly low costs, especially if an executing control device is also used for further purposes and is therefore present in any case. Suitable data media for furnishing the computer program are, in particular, diskettes, hard drives, flash memories, EEPROMs, CD-ROMs, DVDs, and many others. Downloading of a program via computer networks (internet, intranet, etc.) is also possible.

Further advantages and embodiments of the present invention are evident from the description herein and the Figures.

### BRIEF DESCRIPTION OF THE DRAWINGS

FIG. 1 is a simplified schematic depiction of an assemblage having a generator and an active bridge rectifier.

FIG. 2 shows signal curves to explain the principles of a method according to an embodiment of the present invention.

FIG. 3 illustrates, in the form of a diagram, a method according to an embodiment of the present invention.

### DETAILED DESCRIPTION OF EXAMPLE EMBODIMENTS

In the Figures, elements corresponding to one another are labeled with identical reference characters and are not explained repeatedly.

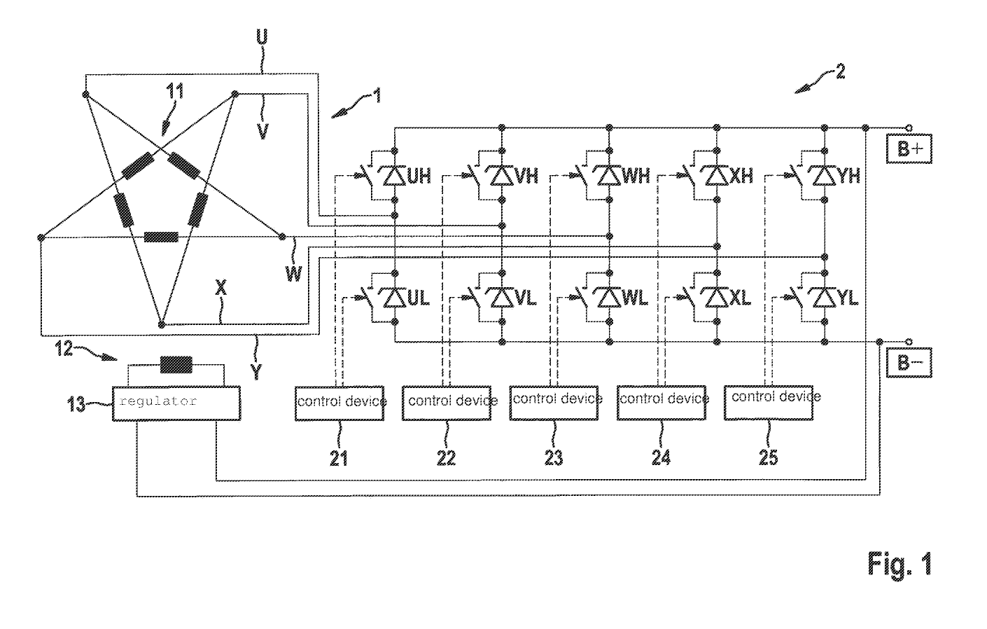

FIG. 1 schematically illustrates an assemblage, having a generator 1 and an active bridge rectifier 2, that can be the basis of an embodiment of the present invention.

Generator 1 encompasses a stator 11 configured with five phases and as a pentagram circuit, and a rotor 12. The individual windings of stator 11 and of rotor 12 are not labeled separately. Generator 1 is connected at five phase terminals U to Y, via respective controllable current valves capable of being switched on and shut off (here labeled UL to YL and UH to YH), respectively to first DC voltage terminal B− and to a second DC voltage terminal B+. The method according to the present invention will be described below with reference to initiation of a phase short circuit in current valves UL to YL of a “low-side” rectifier branch, but can also be carried out with current valves UH to YH in the “high-side” rectifier branch. The current valves participating in each case are referred to in the context of this Application as “first” current valves; at least these are controllable and capable of being switched on and shut off, for example are MOSFETs. The controllable current valves UL to YL and UH to YH that are capable of being switched on and shut off are illustrated in simplified fashion in the Figure as switches having Zener diodes connected in parallel. The Zener diodes here symbolize both the typical breakdown property of a MOSFET above a specific drain-source voltage and the reverse diode present in a MOSFET.

Current valves UH to YH and UL to YL are respectively controllable by way of decentralized control devices 21 to 25, as illustrated here by dashed addressing arrows. A generator regulator 13 evaluates a voltage present between DC voltage terminals B+ and B− (DC voltage terminal B− can be connected to ground) and regulates the power output of generator 1, for example by pulse width modulated application of current to the excitation winding of rotor 12.

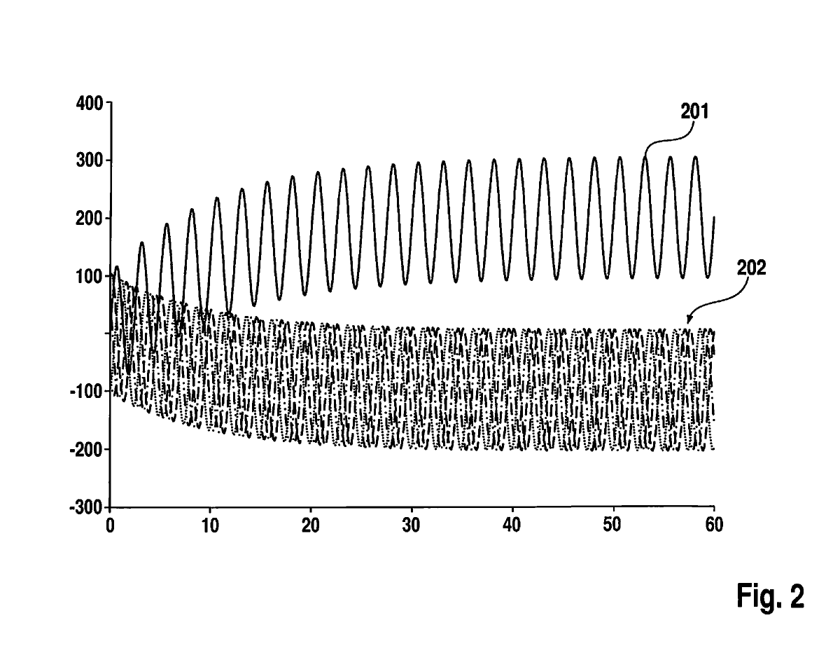

FIG. 2 illustrates signal curves of phase currents in an assemblage having a generator and an active bridge rectifier, for example in accordance with FIG. 1, in order to explain the principles of a method in accordance with an embodiment of the invention. The phase currents are plotted on the ordinate (in amperes) against time (in milliseconds) on the abscissa. The example shows the effects that result when one of the phases is permanently short-circuited to ground (see B− in FIG. 1) (the corresponding current curve is labeled 201), while the other phases (the corresponding current curves are labeled 202) are in ordinary rectification mode, i.e., continuously switching between the potential of B+ and of B−. As explained, such an effect can occur, for example, when a switching threshold for shutting off a corresponding current valve can no longer be reached because of an excessively high DC proportion in the corresponding phase. The result is that the current of the phase short-circuited to ground (current curve 201) is permanently positive.

If such an effect occurs, switching under load can no longer be avoided. In order to minimize stress on the current valves, however, switching should not occur at the maximum if at all possible.

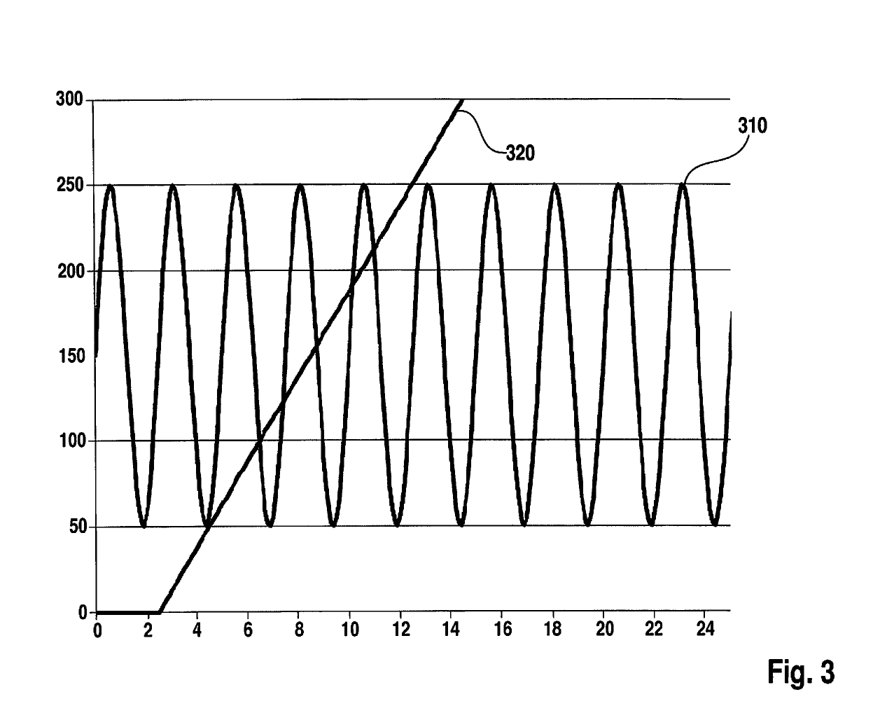

The present invention deals with this problem as illustrated in FIG. 3. FIG. 3 depicts a corresponding phase current, highly enlarged and labeled 310. The phase current 310 is plotted (in amperes) on the ordinate against a time (in milliseconds) on the abscissa. In the example depicted, it oscillates between a value of 50 and a value of 250 amperes, i.e., it no longer reaches the zero value.

A maximum value, used according to the present invention, with which the phase current 310 is compared is labeled 320. This value is equal to 0 amperes at the beginning and is elevated in ramp fashion, i.e., here in the form of a linear function, starting at a time of 2.5 milliseconds. At a time of, for example, 6 milliseconds, the phase current 310 is below the maximum value 320 for the first time, and a corresponding current valve can be shut off.

1-12. (canceled)

13. A method for controlling a multi-phase electric machine, operable at least in generator mode, whose phase terminals in an active bridge rectifier are respectively connected, via controllable first current valves capable of being switched on and shut off, to a first DC voltage terminal and via second current valves to a second DC voltage terminal, the method comprising:
in a generator mode of the electric machine, switching on the first current valves when an output voltage between the first DC voltage terminal and the second DC voltage terminal has exceeded an upper threshold value at an exceedance point in time, and shutting off the first current valves again only once the output voltage has subsequently fallen below a lower threshold value at a shortfall point in time;
wherein the first current valves are shut off again after the shortfall point in time individually, and each only when a respective indication value, which characterizes a current flow in the phase terminal associated with the respective current valve, exhibits a predetermined property, the predetermined property encompassing the indication value exhibiting a minimum determined by way of a determination specification.

14. The method as recited in claim 13, wherein the predetermined property encompasses the indication value being below a maximum value, the maximum value being elevated during a time span that is after the shortfall point in time.

15. The method as recited in claim 14, wherein the maximum value at the shortfall point in time initially corresponds to a zero value of a current flow in the phase terminal associated with the respective current valve.

16. The method as recited in claim 15, wherein the maximum value is elevated, starting from the zero value, at the earliest after a predefined waiting time after the shortfall point in time has elapsed.

17. The method as recited in claim 16, wherein the waiting time is predefined as a function of a rotation speed of the electric machine.

18. The method as recited in claim 14, wherein elevation of the maximum value occurs at least intermittently linearly with a predefined steepness, and/or in the form of a nonlinear function.

19. The method as recited in claim 18, wherein the steepness and/or at least one parameter of the nonlinear function is set as a function of a difference between the indication value and the maximum value.

20. The method as recited in claim 13, wherein the indication value is at least one of a measured current value, a voltage drop across the respective first current valve, and a value derived therefrom.

21. A control unit designed to control a multi-phase electric machine, operable at least in generator mode, whose phase terminals in an active bridge rectifier are respectively connected, via controllable first current valves capable of being switched on and shut off, to a first DC voltage terminal and via second current valves to a second DC voltage terminal, the control unit designed to:
in a generator mode of the electric machine, switch on the first current valves when an output voltage between the first DC voltage terminal and the second DC voltage terminal has exceeded an upper threshold value at an exceedance point in time, and shut off the first current valves again only once the output voltage has subsequently fallen below a lower threshold value at a shortfall point in time;
wherein the first current valves are shut off again after the shortfall point in time individually, and each only when a respective indication value, which characterizes a current flow in the phase terminal associated with the respective current valve, exhibits a predetermined property, the predetermined property encompassing the indication value exhibiting a minimum determined by way of a determination specification.

22. A non-transitory machine-readable memory medium on which is stored a computer program for controlling a multi-phase electric machine, operable at least in generator mode, whose phase terminals in an active bridge rectifier are respectively connected, via controllable first current valves capable of being switched on and shut off, to a first DC voltage terminal and via second current valves to a second DC voltage terminal, the computer program, when executed by a processor, causing the processor to perform:
in a generator mode of the electric machine, switching on the first current valves when an output voltage between the first DC voltage terminal and the second DC voltage terminal has exceeded an upper threshold value at an exceedance point in time, and shutting off the first current valves again only once the output voltage has subsequently fallen below a lower threshold value at a shortfall point in time;
wherein the first current valves are shut off again after the shortfall point in time individually, and each only when a respective indication value, which characterizes a current flow in the phase terminal associated with the respective current valve, exhibits a predetermined property, the predetermined property encompassing the indication value exhibiting a minimum determined by way of a determination specification.
